(19) United States
(12) Patent Application Publication
(10) Pub. No.: US 2010/0149531 A1
(43) Pub. Date: Jun. 17, 2010

(54) APPARATUS AND METHOD FOR OBJECT AUTHENTICATION USING TAGGANT MATERIAL

(75) Inventor: Shu Tuen TANG, Hong Kong (HK)

Correspondence Address: BYIP, LTD., P.O. BOX 1484, GENERAL POST OFFICE, HONG KONG, HK

(73) Assignee: Allegro Asia Technology (HK) Ltd.

(21) Appl. No.: 12/620,578

(22) Filed: Nov. 17, 2009

Related U.S. Application Data
(60) Provisional application No. 61/122,362, filed on Dec. 13, 2008.

(51) Int. Cl. G01J 3/30; G01J 1/58

(52) U.S. Cl. 356/317; 250/458.1; 250/459.1

(57) ABSTRACT

An object authentication system for authenticating an object includes a taggant material applied to the object; a database storing data related to the excitation-emission properties of the taggant material and to an identity of the object; and an authentication reader. The authentication reader includes an excitation source for emitting light for exciting the taggant material, an emission detection device for detecting light emission of the excited taggant material, and a processing unit for analyzing the detected light emission, comparing the detected light emission profile with data stored in the database, and thereby verifying the identity of the object. The taggant material includes a fluorescent material and the taggant material is applied to the object by being mixed into the raw material of the object, being integrated with a portion of the object, or being attached to the object by an adhesive material. A method for authenticating an object is also provided.

### CROSS-REFERENCE TO RELATED APPLICATIONS

This application claims the benefit of U.S. Provisional Patent Application Ser. No. 61/122,362, filed on Dec. 13, 2008; the contents of which is hereby incorporated by reference.

### FIELD OF THE PATENT APPLICATION

The present invention generally relates to authentication technologies and more particularly to an apparatus and a method for object authentication using a taggant material.

### BACKGROUND

Technologies have been proposed to defeat or reduce the counterfeiting and parallel importing of products. Most of them contain one or more protection features that are recognizable either by a customer's bare eyes or by a special tool. These measures can be classified into the following types with different levels of security. A level 1 measure involves features that can be recognized overtly with bare eyes by an end customer of the product. Technologies such as holograms and marks by optically variable ink (OVI) belong to this group. In the hologram case, one is looking for a specially designed holographic pattern. In the OVI case the marked pattern shows different colors when viewed at different angles. A level 2 measure involves covert or semi-covert features that require a simple and easily obtainable detection device, such as UV (ultraviolet)/IR (infrared) (up-conversion) ink in banknotes. In this case one needs only a UV lamp or an IR laser pen for verification. When light in an appropriate waveband is illuminated onto the UV/IR ink, the UV/IR ink emits visible light, which can be observed readily by bare eyes. A level 3 measure involves features that are known only to the brand manufacturer of the product and can be verified by dedicated tools that cannot be obtained commercially in the market.

### SUMMARY

The present patent application is directed to an object authentication system for authenticating an object. The object authentication system includes a taggant material applied to the object; a database storing data related to the excitation-emission properties of the taggant material and to an identity of the object; and an authentication reader including an excitation source for emitting light for exciting the taggant material, an emission detection device for detecting light emission of the excited taggant material, and a processing unit for analyzing the detected light emission, comparing the detected light emission profile with data stored in the database, and thereby verifying the identity of the object. The taggant material includes a fluorescent material and the taggant material is applied to the object by being mixed into the raw material of the object, being integrated with a portion of the object, or being attached to the object by an adhesive material.

The authentication reader may further include an output device connected to the processing unit. The output device may be configured for outputting the result of the authentication to a user.

The taggant material may form a pattern on the object. The concentration or the composition of the taggant material may vary at different portions of the pattern.

The authentication reader may further include a plurality of light delivery optical fibers for delivering light emitted by the excitation source to the taggant material and a light collection optical fiber for collecting light emitted by the excited taggant material and delivering the collected emission to the emission detection device.

The emission detection device may include a RGB sensor. The RGB sensor may be configured for outputting the RGB components and the total intensity of the light emitted by the excited taggant material to the processing unit.

The emission detection device may include a spectrometer. The spectrometer may be configured for outputting to the processing unit the intensity of the light emitted by the excited taggant material over the complete emission spectrum.

In another aspect, the present patent application provides a method for authenticating an object. The method includes: applying a taggant material to the object; exciting the taggant material with light emitted by an excitation source; detecting light emission of the excited taggant material; and analyzing the detected light emission, comparing the detected light emission profile with data stored in a database that stores data related to the excitation-emission properties of the taggant material and related to an identity of the object, and thereby verifying the identity of the object. The step of applying the taggant material to the object includes mixing the taggant material into the raw material of the object, integrating the taggant material with a portion of the object, or attaching the taggant material to the object with an adhesive material.

In yet another aspect, the present patent application provides an apparatus for authenticating an object, the object being applied with a taggant material. The apparatus includes a database storing data related to the excitation-emission properties of the taggant material and to an identity of the object; an excitation source for emitting light for exciting the taggant material; an emission detection device for detecting light emission of the excited taggant material; a plurality of light delivery optical fibers for delivering light emitted by the excitation source to the taggant material; a light collection optical fiber for collecting light emitted by the excited taggant material and delivering the collected emission to the emission detection device; a processing unit for analyzing the detected light emission, comparing the detected light emission profile with data stored in the database, and thereby verifying the identity of the object; and an output device connected to the processing unit, the output device being configured for outputting the result of the authentication to a user. The light delivery optical fibers and the light collection optical fiber are bundled together to form a probe.

### BRIEF DESCRIPTION OF THE DRAWINGS

FIG. 1 illustrates three methods for applying a taggant material onto an object according to an embodiment of the present patent application.

FIG. 2 shows that different parts of a taggant pattern are made of different taggant materials or the same taggant material with different concentrations.

FIG. 3 shows a block diagram of an object authentication system according to an embodiment of the present patent application.

FIG. 4 shows a fiber coupled light source in the object authentication system depicted in FIG. 3.

FIG. 5 shows a RGB sensor of an emission detection device with output signals being normalized and detecting area being divided into RGB and clear parts in the object authentication system depicted in FIG. 3.

FIG. 6 illustrates an authentication reader probe in an object authentication system according to another embodiment of the present patent application.

FIG. 7 is a typical authentication work flow according to an embodiment of the present patent application.

FIG. 8 illustrates an output of a spectrometer used in the object authentication system depicted in FIG. 6.

FIG. 9 shows a single peak emission profile (left) and its digitized bar graph (right) according to yet another embodiment of the present patent application.

### DETAILED DESCRIPTION

Reference will now be made in detail to a preferred embodiment of the apparatus and the method for object authentication using a taggant material disclosed in the present patent application, examples of which are also provided in the following description. Exemplary embodiments of the apparatus and the method for object authentication using a taggant material disclosed in the present patent application are described in detail, although it will be apparent to those skilled in the relevant art that some features that are not particularly important to an understanding of the apparatus and the method for object authentication using a taggant material may not be shown for the sake of clarity.

Furthermore, it should be understood that the apparatus and the method for object authentication using a taggant material disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

According to an embodiment of the present application, an object authentication system may include the following aspects: the process of developing a taggant material, methods for applying the taggant material to an object, a database to store the emission characteristics of the taggant material, an authentication reader that contains illumination sources and emission detectors, and a central processing unit such as MCU (microcontroller unit) included in the authentication reader for running a verification algorithm. The above aspects of the embodiment are respectively described below.

I. Taggant Material

A taggant material used in this embodiment includes at least a fluorescent material that has a certain emission spectrum when exposed to a certain range of excitation electromagnetic waves, such as X-ray, UV (Ultraviolet) light, visible light or IR (Infrared) light. The emission can be in any or all of the UV, visible or IR spectrum range. The fluorescent material can be organic or inorganic in nature and solid powder or liquid in form. Each fluorescent material has its own characteristic excitation and emission spectrum. Mixtures of different fluorescent materials in different ratios, which have different excitation and emission profiles, may be used as the taggant materials. The mixture components may have the same or different excitation wavebands.

In the present patent application, emission peaks are not the only characteristic of concern. The whole spectrum profile is also important. Even for a single peak emission, emission amplitudes of neighboring wavelengths may also be measured and taken into account. In addition, for some fluorescent materials, the dynamic characteristics of the emission, such as the emission response time and decay time may also be utilized as significant verification criteria. The analysis of the emission profiles will be described in more detail later.

II. Methods for Applying the Taggant Material to an Object

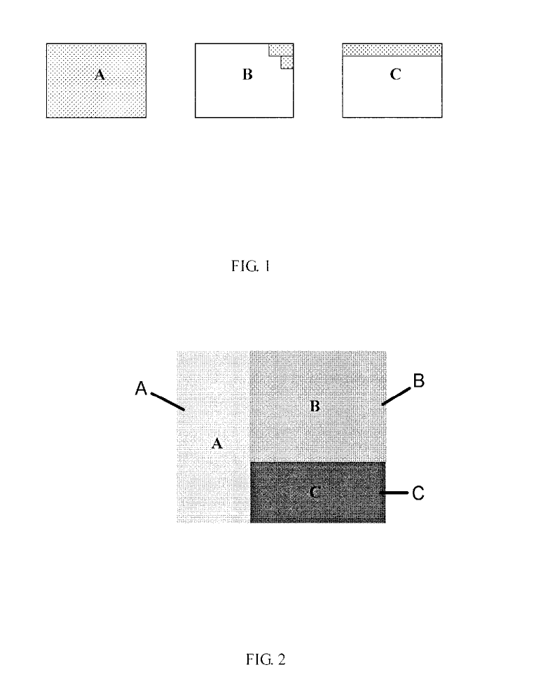

FIG. 1 shows three methods for applying a taggant material onto an object. Referring to FIG. 1, the taggant material can be mixed into the raw material of the object (as shown in the part A of FIG. 1) or integrated with some integral components of the object (as shown in the part B of FIG. 1). By this means, when the manufacturing process of the object is completed, the taggant material is found as an integral part of the object. For example, if the taggant material is in a powder form, it may be mixed with plastic master beads, paper pulps or adhesives in many plastic or glass products. In fact, with an appropriate carrier, the taggant material in powder form can be added to virtually all kinds of materials, such as glass, metal, plastic, ceramic, paper, cloth, leather and so on.

Referring to the part C of FIG. 1, the taggant may also be applied onto the object's surface by ink, paint, epoxy or lacquer that has good adhesion to the object or its packaging material. It is also possible that the taggant material is applied during a surface coating or finishing process. Further, the taggant material may alternatively be added to a printed label or tag, which is then stuck onto the object.

When applying the invisible taggant material onto the object, it may be just a patch of certain geometrical shape or in a designed pattern, such as a one-dimensional (1-D) or two-dimensional (2-D) barcode, or a logo or image. It may also be overlaid onto a visible 1-D or 2-D barcode, or a company name or logo. As shown in FIG. 2, different taggant materials may be used in different parts of the taggant pattern, or alternatively the same taggant material with different concentrations may be applied to the different parts. A combination of the above techniques may be applied to make unique authentication patterns.

III. Authentication Reader

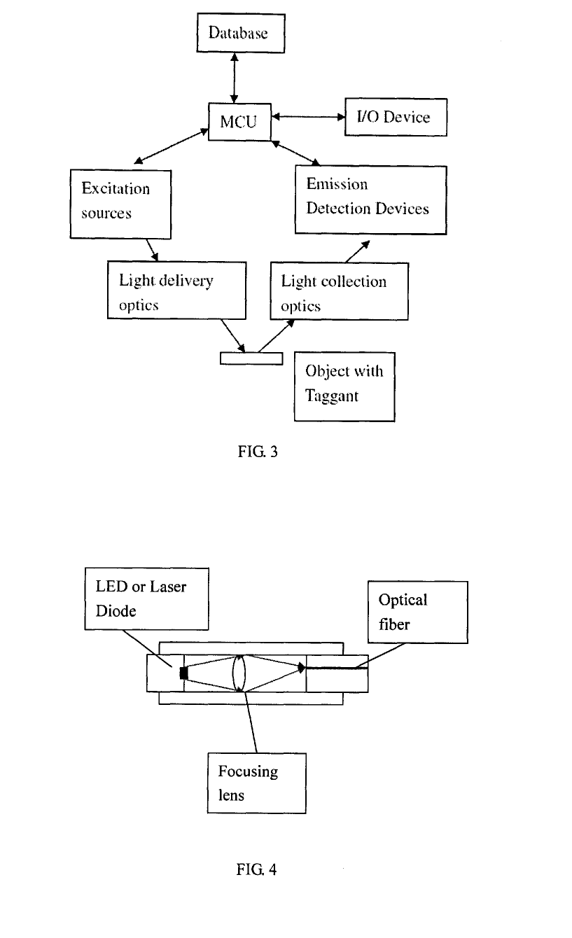

An authentication reader is included in the object authentication system for acquiring information from the taggant pattern, conducting analysis based on the acquired information and authenticating the object. The authentication reader may include an excitation source, an emission detection device, an analysis module that includes a processing unit (MCU; microcontroller unit), a database and I/O (input/output) devices, as illustrated in FIG. 3.

1. Excitation Source

The choice of excitation sources depends on the type of the taggant material or the taggant mixture in use. In general, taggant materials are either UV or IR light excitable. Light in any other wavelength ranges may also be used to excite a taggant material or mixture, for example X-ray. The light source used for the excitation source may be LED (light-emitting diode), laser diode, Xenon lamp or any other types of light (electromagnetic wave) emitting devices.

In the authentication reader, there may be more than one excitation source of the same kind (in order to enhance the excitation power) or of different kinds (in order to be suited for different components of the taggant mixture). Different kinds of light emitting sources may be configured to illuminate the object simultaneously or sequentially. According to this embodiment, a typical authentication reader normally has at least one UV and one IR light source.

In addition to the excitation source itself, there are also light delivery optics in the authentication reader such as focusing lens, color filters, reflectors and optical fibers for optimized light or photon delivery. For a fiber optical light delivery system, it is essential to use a focusing lens for coupling light onto the small optical fiber core with a limited acceptance angle, as illustrated in FIG. 4. The focusing lens used must have a good transmission for the particular light source waveband.

2. Emission Detection Device

The taggant emission in this embodiment is generally in the visible light to IR light spectrum range, while light emission in other wavelength ranges is also possible. In this embodiment, the emission detection device includes a RGB sensor that can be used to get the RGB components of the taggant emission or the resulting color of the emission. As different taggant materials may have different emission spectrum or color, their RGB output are also different, which may be used as a good identifier for low cost applications.

FIG. 5 shows a RGB sensor of an emission detection device with output signals being normalized and detecting area being divided into RGB and clear parts. The RGB sensor in general has 4 output channels for the R, G and B components and the total light intensity W. The RGB channels thus give the color of the taggant emission and the total light intensity channel indicates the taggant concentration. The output format can either be in voltage, current or pulse frequency.

In another embodiment of the present patent application, a spectrometer is used in the emission detection device to provide a higher level of security. It avoids the problem of metamerism, which is confusion between taggant materials with the same color but different emission spectra. The taggant emission may have an output light intensity in a wide wavelength range and have a resolution from several nanometers to less than 1 nanometer. By using the spectrometer, the complete emission spectrum profile can be obtained. The selection of the spectrometer (over applicable wavelength range, sensitivity and resolution) depends on the taggant material used and the target emission wavelengths for authentication.

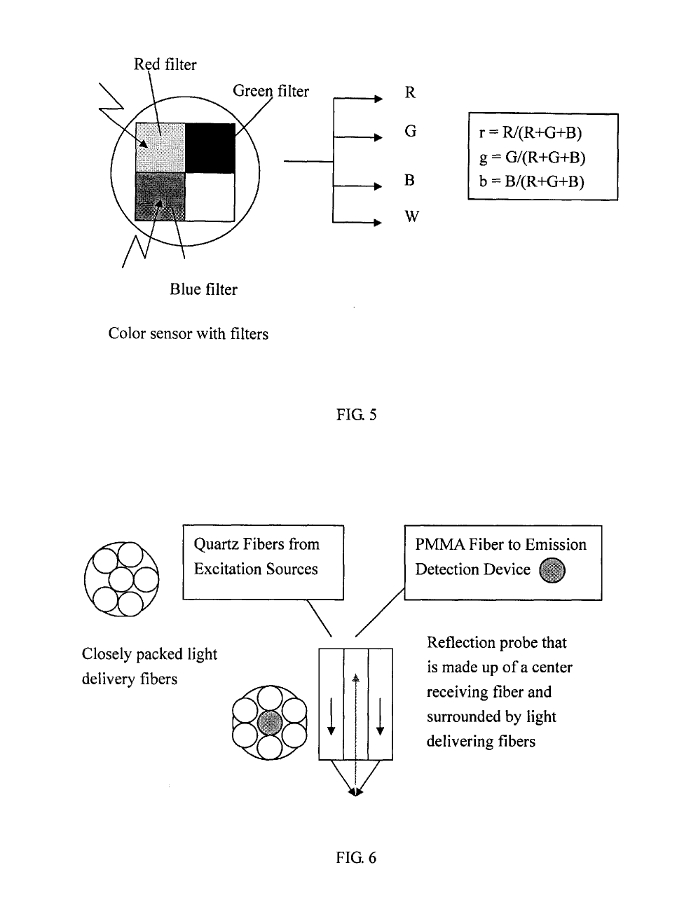

The associated optical components for the emission detection device may include collection lens, color filters, reflectors and optical fibers. In this embodiment, multiple light delivery optical fibers for delivering light emitted by the excitation source to the taggant material and a light collection optical fiber for collecting light emitted by the excited taggant material and delivering the collected emission to the emission detection device can be bundled together to form a probe. Such a reader head structure can help to reduce the size of the reader head and also provide an efficient way for reflected/emitted light collection. In order to enhance the signal to noise ratio and thus render the measurement of weak signals, the optical fiber probe has several unique structural features. First, the excitation light delivery fibers can be made of quartz material that has a high transmission for electromagnetic radiations ranging from ultra violet to infra red spectrum. Second, the collection fiber can be made of a PMMA (Poly Methyl Methacrylate) material that allows visible light to pass through, but absorbs ultraviolet and infrared light reasonably well. This material combination for the reflection probe can effectively separate the excited visible emission from light of the excitation source without using separate band pass filters. Third, the arrangement of the multiple light delivery fibers in this embodiment is different from that in conventional reflection probes. In a conventional reflection probe, the light delivery fibers are arranged in a circle and the center part is left void. In this embodiment, multiple fibers are packed to avoid a center hole, as illustrated in FIG. 6, with the light collection optical fiber in the center of the probe and the light delivery optical fibers around the light collection optical fiber. Such arrangement, as illustrated in FIG. 6, effectively increases the efficiency of the excited light collection.

3. Analysis Module, Database and I/O Devices

The analysis module has two aspects: analysis hardware and analysis software. The analysis hardware includes a MCU and associated electronic circuits for storing and running the analysis algorithm. The emission detection device is configured to send the emission spectrum information to the MCU, which may be the RGB components or the complete spectral data. After getting the emission data, the MCU starts to perform diagnostic analysis. It retrieves the existing taggant data from a database and compares that with the emission data received from the emission detection device. The comparison result may then be sent to an output device to notify a user.

In the object authentication system of this embodiment, the analysis hardware and the output device can be a desktop or notebook computer. In a standalone mobile application (field type), the analysis hardware may be a MCU component with associated electronic circuits and the output device may be a small LCD (Liquid Crystal Display) panel. The database may either be built-in to the system or be connected to the system through a wired or wireless means such as the Internet or an Intranet.

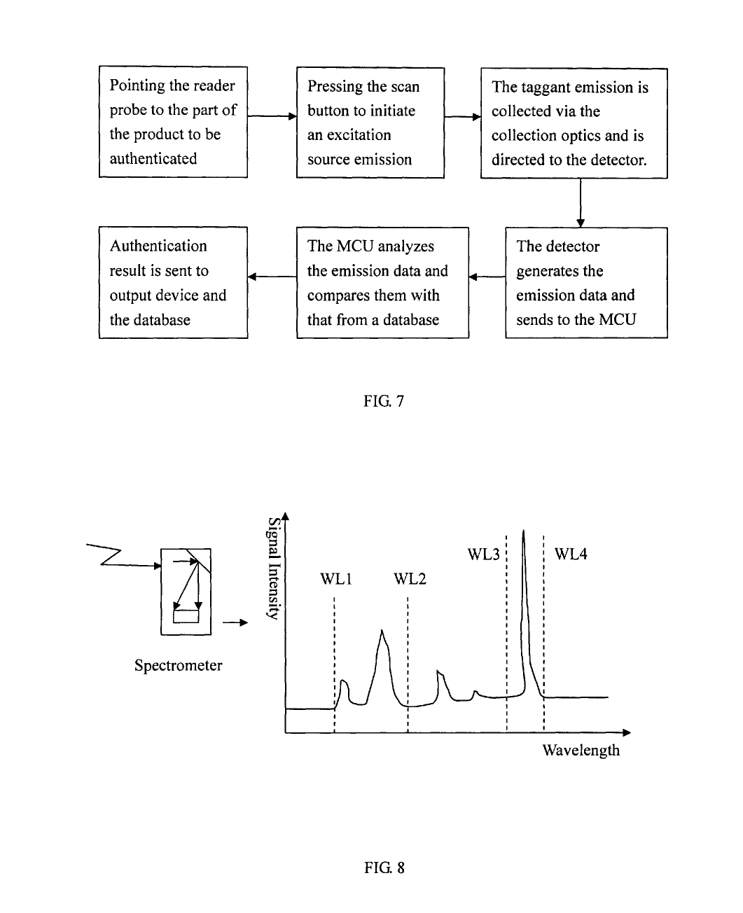

The MCU controls the flow of the authentication procedures. Referring to FIG. 7, a typical object authentication procedure in this embodiment includes:

1) Pointing the authentication reader or the probe tip to a designated part of an object to be authenticated;
2) Pressing the scan button so that the excitation light source is triggered for an emission; for multiple excitation light sources, they are programmed to be turned on simultaneously or sequentially;
3) The taggant emission is collected by the collection optics and then directed to the spectrometer or the RGB sensor;
4) Spectral or RGB data are transferred to the MCU for analysis;
5) The analysis process requires connection to a database for object authentication;
6) The authenticating result is sent to the output device; the result is also stored in the authentication reader or in the database for further analysis.

It is understood the system may include one or more input devices for the user to input commands to direct or interact with the authentication process.

IV. Authentication Methods

The format for the data representing the taggant emission depends on the emission detection device in use. In the embodiment where a RGB sensor is used, the 4 outputs respectively correspond to Red, Green, Blue and total intensity. The relative intensity of the R, G, B components can be normalized to give proportional r, g, b values, as shown in FIG. 5. For a particular taggant emission color, its r, g, and b values serve as a signature for that taggant.

Another layer of protection can be imposed when the total light intensity is concerned. It serves as an additional verification criteria that relates to the taggant concentration. Therefore for a certain product lot one may simply double the taggant concentration to make a difference.

Yet another layer of protection is made possible by the fast response of a RGB sensor. One can record the response time (rise time and/or decay time) of the taggant emission and set it as yet another verification criteria. In this embodiment, the database record format for a particular taggant may be taggant name-rgb values, intensity, decay time-product information.

In the embodiment where a spectrometer is used, the spectrometer has a wavelength dispersive element and is able to detect the complete emission spectrum. The data output of the spectrometer may be in the form of relative intensities versus wavelengths, as illustrated in FIG. 8. In this case, the emission peaks are recorded and they naturally become the fingerprint of that taggant.

There are three progressive levels of security in the analysis of the emission profile. First, only the wavelengths where the emission intensity peaks (referred to as “peak wavelengths” hereafter) are checked. Second, the peak wavelengths and the relative amplitudes of the emission intensity at the peak wavelengths are checked. Third, the peak wavelengths, the relative intensity amplitudes at the peak wavelengths and the amplitudes of the emission intensity at “all” wavelengths are checked. For taggants that each has many unique peak wavelengths, the first level is good enough for uniquely identifying a taggant. For taggants that have many common peak wavelengths and only differ in the emission intensity amplitudes at the peak wavelengths, the second level of analysis is required. In that case, the ratio of certain pairs of peak wavelengths and other logical constraints may be imposed. These logical constraints may include the emission intensity amplitude levels, their ratios, their orders according to the amplitudes and so on. For taggants that have one or two peak wavelengths only and have a characteristic emission profile, the third level of analysis may be a good choice.

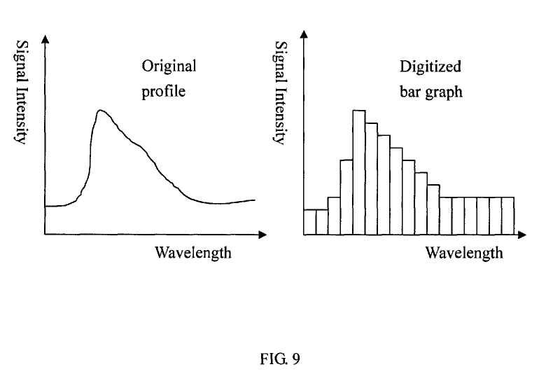

As illustrated in FIG. 9, the emission intensities over the complete emission spectrum may be digitized to consecutive segments so that a bar graph can be formed and the amplitude of each bar can be recorded and analyzed. The width of each bar is, for example, 25 nm or 50 nm in the visible wavelength range. To verify a certain profile, the amplitude of each bar is required to be between certain upper and lower limits. There are a lot of UV phosphor blends that emit only one or two peaks, but each has a different emission profile. Since the complete emission spectrum is obtained, which is in the visible range, the emission color can also be calculated. This also serves as a verification characteristic. In addition, the integration time of a spectrometer can be set to be proportional to the emission intensity. This may give one more dimension in the authentication algorithm. Therefore a database record format for a particular taggant in this case may be taggant name-excitation source-relevant wavelength range-peak wavelengths, peaking intensity amplitude-emission color-decay time-logical constraints-product information. It is noted that in every defined wavelength range, there may be one peak or more than one peak. Furthermore, there can be more than one relevant wavelength range under analysis.

In the case when the complete emission profile is analyzed, a database record format for a particular taggant may be taggant name-excitation source-wavelength range-wavelength step size-bar amplitudes-emission color-decay time-product information. The above database format can be extended if there is more than one excitation source.

While the present patent application has been shown and described with particular references to a number of embodiments thereof, it should be noted that various other changes or modifications may be made without departing from the scope of the present invention.

What is claimed is:

1. An object authentication system for authenticating an object comprising:
a taggant material applied to the object;
a database storing data related to the excitation-emission properties of the taggant material and to an identity of the object; and
an authentication reader comprising an excitation source for emitting light for exciting the taggant material, an emission detection device for detecting light emission of the excited taggant material, and a processing unit for analyzing the detected light emission, comparing the detected light emission profile with data stored in the database, and thereby verifying the identity of the object; wherein:
the taggant material comprises a fluorescent material and the taggant material is applied to the object by being mixed into the raw material of the object, being integrated with a portion of the object, or being attached to the object by an adhesive material.

2. The object authentication system of claim 1, wherein the authentication reader further comprises an output device connected to the processing unit, the output device being configured for outputting the result of the authentication to a user.

3. The object authentication system of claim 1, wherein the taggant material forms a pattern on the object, and the concentration or the composition of the taggant material varies at different portions of the pattern.

4. The object authentication system of claim 1, wherein the authentication reader further comprises a plurality of light delivery optical fibers for delivering light emitted by the excitation source to the taggant material and a light collection optical fiber for collecting light emitted by the excited taggant material and delivering the collected emission to the emission detection device.

5. The object authentication system of claim 4, wherein the light delivery optical fibers and the light collection optical fiber are bundled together to form a probe.

6. The object authentication system of claim 5, wherein the light collection optical fiber is made of PMMA (Poly Methyl Methacrylate) and arranged in the center of the probe, and the light delivery optical fibers are made of quartz and arranged around the light collection optical fiber.

7. The object authentication system of claim 1, wherein the emission detection device comprises a RGB sensor, the RGB sensor being configured for outputting the RGB components and the total intensity of the light emitted by the excited taggant material to the processing unit.

8. The object authentication system of claim 1, wherein the emission detection device comprises a spectrometer, the spectrometer being configured for outputting to the processing unit the intensity of the light emitted by the excited taggant material over the complete emission spectrum.

9. The object authentication system of claim 7, wherein the processing unit is configured to analyze the RGB components, the total intensity, and the response time of the light emitted by the excited taggant material.

10. The object authentication system of claim 8, wherein the processing unit is configured to analyze the wavelengths at peaks of the intensity of the light emitted by the excited taggant material, the amplitudes of the intensity peaks, or the intensity values over the complete emission spectrum of the excited taggant material.

11. A method for authenticating an object comprising:
applying a taggant material to the object;
exciting the taggant material with light emitted by an excitation source;
detecting light emission of the excited taggant material; and
analyzing the detected light emission, comparing the detected light emission profile with data stored in a database that stores data related to the excitation-emission properties of the taggant material and related to an identity of the object, and thereby verifying the identity of the object; wherein:
the step of applying the taggant material to the object comprises mixing the taggant material into the raw material of the object, integrating the taggant material with a portion of the object, or attaching the taggant material to the object with an adhesive material.

12. The method for authenticating an object of claim 11, wherein the step of applying the taggant material to the object further comprises arranging the taggant material into a pattern and varying the concentration or the composition of the taggant material at different portions of the pattern.

13. The method for authenticating an object of claim 11, wherein the step of detecting light emission of the excited taggant material comprises detecting the RGB components and the total intensity of the light emitted by the excited taggant material.

14. The method for authenticating an object of claim 13, wherein the step of analyzing the detected light emission comprises analyzing the RGB components, the total intensity, and the response time of the light emitted by the excited taggant material.

15. The method for authenticating an object of claim 11, wherein the step of detecting light emission of the excited taggant material comprises detecting the intensity of the light emitted by the excited taggant material over the complete emission spectrum.

16. The method for authenticating an object of claim 15, wherein the step of analyzing the detected light emission comprises analyzing the wavelengths at peaks of the intensity of the light emitted by the excited taggant material, the amplitudes of the intensity peaks, or the intensity values over the complete emission spectrum of the excited taggant material.

17. An apparatus for authenticating an object, the object being applied with a taggant material, the apparatus comprising:
a database storing data related to the excitation-emission properties of the taggant material and to an identity of the object;
an excitation source for emitting light for exciting the taggant material;
an emission detection device for detecting light emission of the excited taggant material;
a plurality of light delivery optical fibers for delivering light emitted by the excitation source to the taggant material;
a light collection optical fiber for collecting light emitted by the excited taggant material and delivering the collected emission to the emission detection device;
a processing unit for analyzing the detected light emission, comparing the detected light emission profile with data stored in the database, and thereby verifying the identity of the object; and
an output device connected to the processing unit, the output device being configured for outputting the result of the authentication to a user; wherein:
the light delivery optical fibers and the light collection optical fiber are bundled together to form a probe.

18. The object authentication system of claim 17, wherein the light collection optical fiber is made of PMMA (Poly Methyl Methacrylate) and arranged in the center of the probe, and the light delivery optical fibers are made of quartz and arranged around the light collection optical fiber.

19. The apparatus for authenticating an object of claim 17, wherein the emission detection device comprises a RGB sensor, the RGB sensor being configured for outputting the RGB components and the total intensity of the light emitted by the excited taggant material to the processing unit, the processing unit being configured to analyze the RGB components, the total intensity, and the response time of the light emitted by the excited taggant material.

20. The apparatus for authenticating an object of claim 17, wherein the emission detection device comprises a spectrometer, the spectrometer being configured for outputting to the processing unit the intensity of the light emitted by the excited taggant material over the complete emission spectrum, the processing unit being configured to analyze the wavelengths at peaks of the intensity of the light emitted by the excited taggant material, the amplitudes of the intensity peaks, or the intensity values over the complete emission spectrum of the excited taggant material.
